(19) United States
(12) Patent Application Publication
(10) Pub. No.: US 2004/0253565 A1
(43) Pub. Date: Dec. 16, 2004

(54) Caption type language learning system using caption type learning terminal and communication network

(75) Inventor: Cheol Kim, Seoul (KR)

Correspondence Address: Warner Norcross & Judd LLP, Intellectual Property Practice Group, 900 Fifth Third Center, 111 Lyon Street, N.W., Grand Rapids, MI, 49503-2487, US

(73) Assignee: Kyu Jin Park

(21) Appl. No.: 10/817,650

(22) Filed: Apr. 2, 2004

Related U.S. Application Data
(62) Division of application No. 09/254,058, filed on Jun. 14, 1999, now abandoned.
Application No. 09/254,058 is a 371 of international application No. PCT/KR98/00202, filed on Jul. 10, 1998.

(30) Foreign Application Priority Data
Jul. 10, 1997 (KR) 1997/32037
Oct. 16, 1997 (KR) 1997/53174

(51) Int. Cl. G09B 19/00; H04N 11/00

(52) U.S. Cl. 434/156

(57) ABSTRACT

A caption type language learning system utilizing a communication network is disclosed. The system includes a captioning language training network server 11 for data-basing the data for respective learning fields. A communication switching station 12 receives the captioning language learning data through the network. A satellite switching station 13 transmits the data suitable to the communication characteristics through a communication network. The system further includes wire and wireless communication terminals 18, 19, 28, 22, 23, 24, 25, 26 and 27 for receiving captioning language learning data from an external communication network. A wireless communication terminal having a captioning language learning function or a captioning language training terminal 21 receives captioning language learning data through the wire switching station 17 or directly from an external communication network. The terminal includes a modem section 31 for receiving the captioning language learning data from the captioning language learning network server 11 through the wire switching station. A communication interface section 32 receives the data from the wire or wireless terminal or a PC in a form readable by the internal devices. An internal captioning language learning data memory section 33 stores the audio and caption data, and a CODEC section 34 converts the audio data to analogue audio data. The terminal further includes an amplifying section 35, an LCD driver 7 for driving an LCD display 38 to display the caption data, and a DSP/CPU section 39 for processing the audio and captioning learning data and for controlling the whole terminal. The caption and audio data can be watched and listened without using the conventional captioning type cassette tape and player. Further, the carrying is convenient, and malfunctions do not occur, so that foreign languages can be learned in a convenient way.

### BACKGROUND OF THE INVENTION

1. Field of the Invention

The present invention relates to a caption type language learning system. Particularly, the present invention relates to a caption type language learning system utilizing a communication network, in which a captioning cassette tape and a captioning cassette player are not used, but a microprocessor having a DSP (digital signal processing) function is used, so that caption displays and audio output would be possible by receiving language learning data through a caption type language learning terminal and through a wire or wireless or satellite communication network or a CATV network.

2. Description of the Prior Art

Conventionally, in learning English, Japanese or other foreign languages, there is used a cassette tape player together with a cassette tape, or a captioning type cassette tape player capable of outputting sounds and captions.

These foreign language learning media have to be carried together with the player, this being a troublesome task. Although they are miniaturized to some degree, there is still a limit to reducing the size of the tape and the mechanism of the player. Therefore, there has been much inconvenience in learning the language during going and coming to and from jobs.

Further, in the case of the captioning type cassette player, due to the maladjustment and wearing degree of the magnetic head and due to the differences of standards between manufacturers, noises can be mixed in the audio signals, or the captioning may be malfunctioned.

Further, when procuring the captioning type cassette tapes, they have to be contracted based on annual basis, or a whole set has to be bought. Further, a captioning type player has to be bought, and therefore, the cost expenditure is great.

Further, when procuring the captioning type player, the motive is just the curiosity, and therefore, once bought, they are frequently left without using.

### SUMMARY OF THE INVENTION

The present invention is intended to overcome the above described disadvantages of the conventional technique.

Therefore it is an object of the present invention to provide a language learning terminal in which even without using a captioning type cassette tape and a captioning type cassette player, the learning of a language is made possible by storing the learning audio and captioning contents in the internal memory by utilizing a microprocessor having a DSP (digital signal processing function.

It is another object of the present invention to provide a captioning type language learning terminal in which even without using a captioning type cassette tape and a captioning cassette player, and without using a modem-installed PC, audio and caption data are received from an external source through an internal modem into a S data memory module to store them there, and when a need arises, the language learning is carried out.

It is still another object of the present invention to provide a wireless communication terminal having a language training function, in which even without using a captioning type cassette tape and a captioning cassette player, and without using a modem-installed PC, audio and caption data are received through an internal modem into a memory module to store them there, thereby making it possible to learn a language.

It is still another object of the present invention to provide an on-line learning system in which data base servers are constructed for respective learning fields by utilizing the language learning terminal, and then, necessary amounts of learning data are supplied to the terminals of users in the form of an information shop through the networks such as internet, intranet and PC communications and the like, thereby inducing a strong motive or interest.

It is still another object of the present invention to provide a captioning type language learning system in which data base servers are constructed for respective learning fields such as audio and caption data and music and game data and the like, and then, when a need arises, the learning data are supplied to the a switching station, and necessary amount of data are supplied to the captioning type language learning terminals of users or to wireless communication terminals (such as pager, PCS, PHS, cellular terminal) of users through the networks such as wire, wireless, or satellite communication networks or CATV networks and the like, so that the learning would be possible any time and anywhere without restricted by places.

In achieving the above objects, the language learning terminal utilizing the DSP function according to the present invention includes: flash memory sections for receiving language learning audio and caption data to store and supply them; an interface section for making external audio and caption data readable by internal devices; a DSP section for separating the received data into audio data and caption data in accordance with CE (caption enable) signals of a CPU during the reception of data from a communication interface through the CPU so as to store the data into the flash memory sections, and for receiving commands through a host interface bus of the CPU during a play to supply caption data of the flash memory sections through the CPU to an LCD display; CODEC sections for receiving mark numbers (for separating regions between a caption and another caption), for receiving a starting address of the caption data and audio data from the flash memory through a RAM section and the DSP section so as to convert the audio signals into analogue audio signals; an amplifying section for amplifying the audio signals of the CODEC section to output them to a speaker or an earphone; an LCD driver for receiving the caption data from the CPU to drive an LCD display section; a rechargeable battery for supplying power to the terminal; and a microprocessor for shifting the CE signal to high H upon finding a caption data among externally received data, for outputting a mark signal and the caption data through the host interface bus to the DSP section, for shifting the CE signal to low L upon encountering relevant audio data to output the audio data to the DSP section, for transmitting a mark number and a play-back command through a bus to the DSP section upon inputting a play switch to read the audio and caption data from the memory section, for converting the caption data of the DSP section into character signals to display them onto the LCD display, for reading a current mark number upon inputting a forward or reverse switch to output a next mark number or the preceding mark number to the DSP section so as to play back next or preceding audio and caption data, for outputting audio and caption data of the memory section through the communication interface to an external apparatus (PC or a base station of the terminal), and for perceiving memory data amount and empty memory capacity through a bus so as to output various information of the DSP section and the terminal to the LCD driver.

In another aspect of the present invention, the captioning type language learning terminal according to the present invention includes: a modem section for receiving captioned learning data, music data, game data and the like from a wired switching station through a wired communication network and through a captioning type language learning network server; an interface section for making external audio and caption data (from a wire or wireless terminal or PC) readable by internal devices; an internal captioning language learning data memory section for receiving language learning audio and caption data to store and supply them; a CODEC section for receiving audio data through a DSP/CPU section from the data memory to convert the audio signals into analogue audio signals; an amplifying section for amplifying the audio signals of the CODEC section to output them to a speaker or an earphone; an LCD driver for receiving the caption data from the DSP/CPU section to drive an LCD display section; and the DSP/CPU section being for separating the received data into audio data and caption data during reception of data from the modem section and a communication interface to store the data into the data memory section, converting relevant audio and caption data to supply them to the LCD display section and the speaker, and playing back next or preceding audio and caption data upon inputting forward or reverse switch.

In still another aspect of the present invention, the wireless data communication terminal having a captioning language training function according to the present invention includes: an RF/IF section for receiving captioning language learning data, music data or game data through an antenna from a communication network to RF-amplify them; a modem section for demodulating the RF-amplified data signals; a protocol control section for receiving the demodulated data signals from the modem section to extract data suitable to various communication protocols such as TDMA, CDMA, FLEX and the like; a CODEC section for receiving audio data to convert the audio signals into analogue audio signals so as to output them to a speaker; a data transmission control section for receiving information data from the protocol control section to selectively transmit them to an external apparatus, to an LCD display, or to a captioning type language learning data memory section; a DSP/CPU section for controlling general wireless communication functions, for storing captioning language learning data into the data memory, for converting audio and caption data upon inputting a play key to supply them to the LCD display and to the speaker, and for playing back next or preceding audio and caption data upon inputting a forward or reverse key; ROM and RAM sections for storing various address data and program data used by the CPU; the internal captioning language learning data memory section for furnishing language learning audio and caption data after receipt of them from external; and a key section having various keys.

In still another aspect of the present invention, the on-line language learning system according to the present invention includes: a data base server for data-basing and storing the captioning language learning data for different learning fields, and various music and game data; a user PC section for receiving various learning data of the data base server (which have been received through on-line networks such as internet, PC communications, private BBS or the like) to store them into an internal auxiliary memory, and having a modem and a communication interface unit for storing learning data received from a language learning terminal; a vending machine section having a modem, a PC, an LCD and key switches for receiving captioning language data, music data and game data from a data base through an on-line network or an exclusive line to store them in a DB unit, for showing a relevant learning data as demonstration in accordance with key manipulations, for filling a terminal, for updating a data base from a vending machine managing PC when new learning data are commercialized; the vending machine PC being for managing a plurality of data filling vending machine sections by a remote control means, and for supplying newly produced data to the vending machine sections; and a terminal section having a base station section, an LCD display section and a memory section including a filling section and a data buffering section, for receiving learning data from the user PC through a communication interface, and for receiving necessary data from the data filling vending machine section so as to carry out language training, and for storing the data of an internal memory through a communication interface unit of the user PC section into an auxiliary memory device.

In still another object of the present invention, the captioning type language learning system according to the present invention includes: a captioning language learning network server for data-basing and storing various captioning language learning data, music data and game data for respective fields to supply the captioning language learning data and the like to users upon needs; a communication switching station for receiving captioning language learning data and the like through internet, PC communication, private BBS or the like; and a communication network consisting of various wire or wireless communication terminals (such as FPLMTS terminal, pager, PCS terminal, PHS terminal, PDA terminal, cellular terminal, wireless CATV receiver, wire CATV receiver, user PC and the like) for receiving captioning language learning data and the like through communication networks using satellite switching station, wireless switching station, wire or wireless CATV station, and wire switching station, and consisting of wireless communication terminals having a captioning language training function or consisting of user captioning language learning terminals for receiving captioning language learning data directly from the communication network or through a wire switching station from one of the various terminals.

### BRIEF DESCRIPTION OF THE DRAWINGS

The above objects and other advantages of the present invention will become more apparent by describing in detail the preferred embodiment of the present invention with reference to the attached drawings in which:

FIG. 1 illustrates the constitution of the captioning language learning system utilizing a communication network according to the present invention;

FIG. 2 illustrates the constitution of the captioning language learning system utilizing the terminal according to the present invention;

FIG. 3 is a block diagram showing the constitution of the captioning language learning terminal according to the present invention;

FIG. 4 is a flow chart showing the operation of the captioning language learning terminal according to the present invention;

FIG. 5 is a block diagram showing the constitution of the captioning language learning terminal utilizing the DSP according to the present invention;

FIG. 6 is a flow chart showing the operation of the captioning language learning terminal utilizing the DSP according to the present invention;

FIG. 7 is a block diagram showing the constitution of the wireless data communication terminal having the captioning language training function according to the present invention;

FIG. 8 is a flow chart showing the operation of the wireless data communication terminal having the captioning language learning terminal according to the present invention;

FIG. 9A illustrates the external contour of the captioning language learning terminal according to the present invention;

FIG. 9B illustrates the external contour of another embodiment of the captioning language learning terminal according to the present invention; and

FIG. 9C illustrates the external contour of the wireless data communication terminal having the captioning language learning terminal according to the present invention.

### DETAILED DESCRIPTION OF THE PREFERRED EMBODIMENT

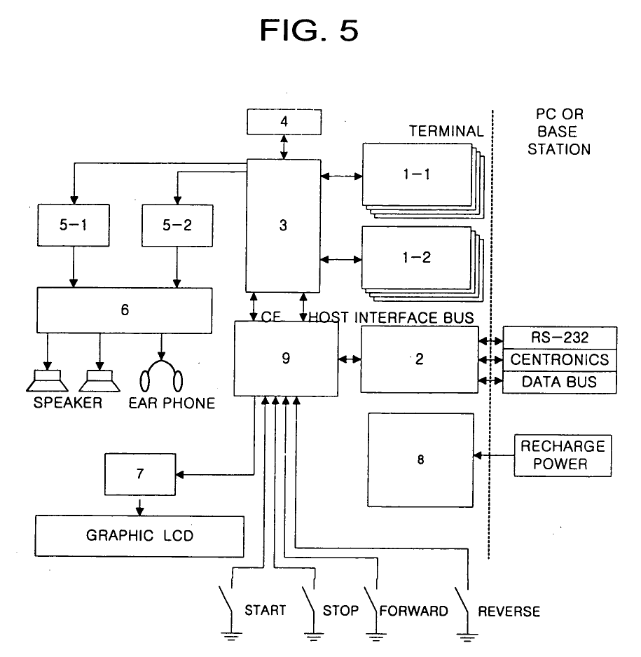

FIG. 5 is a block diagram showing the constitution of the captioning language learning terminal utilizing the DSP according to the present invention.

As shown in the drawing, the captioning language learning terminal utilizing the DSP according to the present invention includes: a memory section 1 for storing learning data; a communication interface 2 for receiving learning data from an external apparatus; a DSP section 3 for processing the captioning and audio learning data; a RAM section 4 for storing addresses; a CODEC section 5 for converting audio data into analogue audio signals; an amplifying section 6; an LCD driver 7 for driving an LCD display for displaying the captioned data; a rechargeable battery section 8; and a microprocessor section 9 for carrying out an overall control on the terminal.

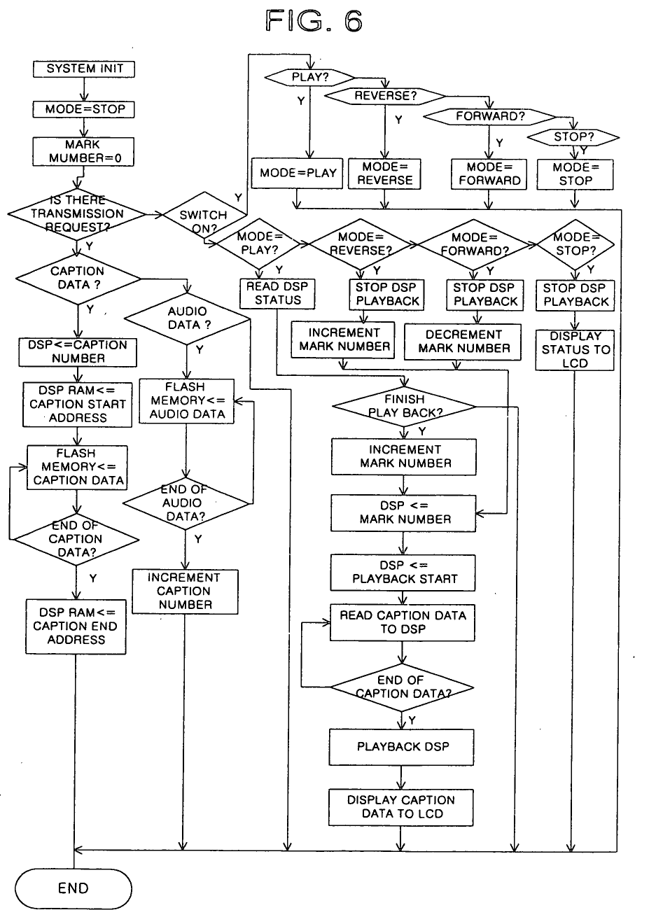

FIG. 6 is a flow chart showing the operation of the captioning language learning terminal of FIG. 5 utilizing the DSP according to the present invention.

When data are supplied from the external, the learning data which are supplied from a PC or a base station are inputted into the microprocessor 9 through the communication interface 2.

If the inputted data are caption data, the microprocessor 9 shifts CE (caption enable) signal to high (H), and outputs a mark number (MARIC) (for separating the region between a caption and another caption) and caption data through a host interface bus to the DSP section 3. For the audio data which corresponds to the caption data, the CE signal is shifted to low (L) to output the audio data to the DSP section 3.

If the inputted data are caption data, the DSP section 3 stores the starting and ending addresses of the mark number and the caption data, and stores the inputted captioning and audio data into flash memory sections 1-1 and 1-2. Under this condition, if the inputted audio data are stereo, then the left and right audio data are stored into the memory sections 1-1 and 1-2.

Meanwhile, if a play switch is inputted into the microprocessor 9, then the microprocessor 9 outputs the mark number and a play-back command through the host interface bus to the DSP section 3. Under this condition, the DSP section 3 reads the starting and ending addresses of the memory section 1 (storing the relevant caption data) from the RAM section 4 based on the received mark number to read the contents of the relevant address of the memory section 1 so as to output them to the microprocessor 9. At the same time, it outputs the audio data (to before the next caption) to the CODEC section 5.

The caption data which have been transmitted from the microprocessor 9 are converted into character signals to be outputted to the LCD driver 7.

The LCD driver 7 drives the LCD display to display the relevant captions.

Meanwhile, the audio data which have been outputted to the CODEC section 5 are converted into analogue signals by the section 5. Then they are amplified by the amplifier 6 to be outputted to a speaker or an earphone.

When a forward switch or a reverse switch is inputted, the microprocessor 9 reads the current mark number to output the next mark number or the preceding mark number to the DSP section 3, so that the next or preceding audio data can be played in the above described manner.

When the data of the memory section 1 are transmitted to a base station (which includes a charging circuit and a data buffer, and in which a PC or a terminal is placed), the microprocessor 9 receives the audio and caption data from the memory section through the DSP section 3 to output them through the communication interface 2 to the PC or to the base station.

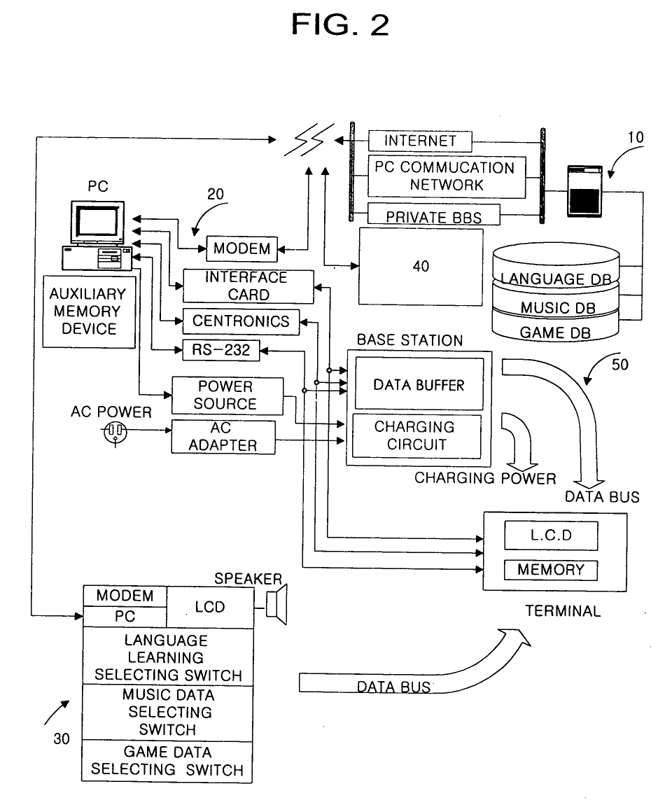

FIG. 2 is a block diagram showing the constitution of the captioning language learning system utilizing the terminal of FIG. 5 according to the present invention. This system includes: a data base server 10 for storing the data for respective learning fields by data-basing them; a user PC section 20 for receiving and storing the learning data through the on-line network; a data filling vending machine section 30 for filling necessary data into the terminal from among the data-based data; a vending machine managing PC section 40 for managing the vending machine section 30 by a remote control means; and a terminal section 50 for receiving the data from the user PC section 20 or from the vending machine section 30 to carry out language training.

When there is a request from the user, the captioning language learning data which have been stored in the data base server 10 are transferred into an internal auxiliary memory device through internet, intranet, PC communication, private BBS or the like and through the modem of the user PC section 20.

The data which have been stored in the auxiliary memory device of the user PC section 20 are transmitted to the terminal of the terminal section 50 through a particular interface card or a communication interface bus such as a PC serial bus RS-232 or a parallel bus (IEEE) depending on the user's need. Thus the data are stored in the internal memory of the terminal of the present invention to be utilized for language learning. Or the data are transmitted from the user PC section 20 to the base station of the terminal section 50 to be temporarily stored in the internal data buffer section. The data can be transmitted to the terminal during the time when the terminal is being charged.

Meanwhile, the data which have been stored in the memory of the terminal pass through a data buffer of the base station or pass through the interface communication bus of the user PC section 20, to be transferred to the auxiliary memory device of the user PC section 20.

Meanwhile, when the data are to be received at an outdoor site, the data filling vending machine section 30 is utilized. Under this condition, the desired kind of the learning data is selected by means of a key switch of the vending machine. Thus the data selected from among the data-based data (received from the data base server 10) are charged into the terminal.

The vending machine section 30 is managed by the vending machine managing PC section 40, and receives updated data from the PC section 40.

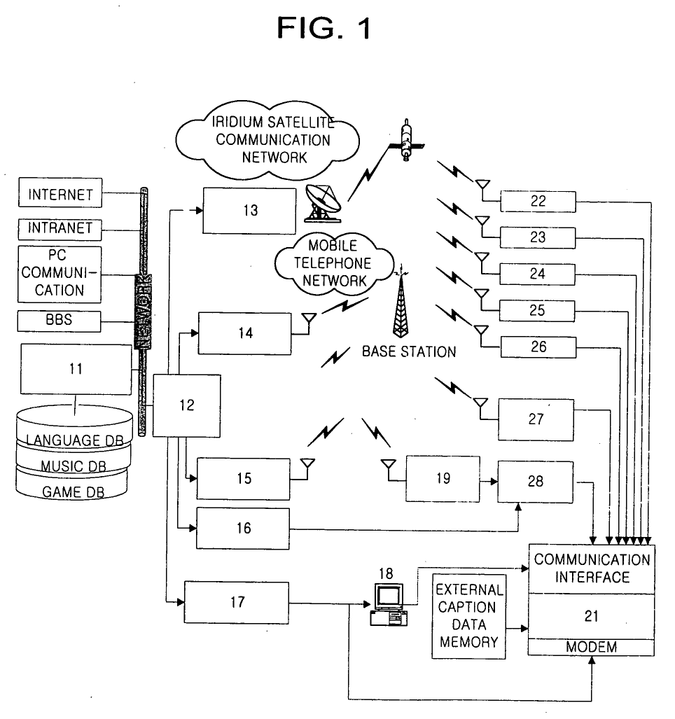

FIG. 1 is a block diagram showing the constitution of the captioning language learning system utilizing a communication network according to the present invention.

As shown in the drawing, the system includes: a captioning language training network server 11 for data-basing the data for respective learning fields; a communication switching station 12 for receiving the captioning language learning data through the network; a satellite switching station 13 for transmitting the data suitable to the communication characteristics through a communication network; a wireless switching station 14; a wireless CATV station 15; a wire CATV station 16; a wire switching station 17; wire and wireless communication terminals 18, 19, 28, 22, 23, 24, 25, 26 and 27 for receiving captioning language learning data from an external communication network; and a wireless communication terminal having a captioning language learning function or a captioning language training terminal 21 for receiving captioning language learning data through the wire switching station 17 or directly from an external communication network.

When there is a request from the user, the captioning language learning data which have been stored in the captioning language learning network server 11 are transferred to the communication switching station 12 through internet, intranet, PC communication, private BBS or the like.

The data which have been transmitted to the communication switching station 12 are transferred to the satellite switching station 13, the wireless switching station 14, the wireless CATV station, the wire CATV station 16, or the wire switching station 7 in accordance with the user's communication environment. The data are further transferred to one of the various user terminals such as FPLMTS terminal 22, the pager 23, the PCS terminal 24, the PHS terminal 25, the PDA terminal 26, the digital cellular terminal 27, the wireless CATV receiver 19, and the wire CATV receiver 28. The wire or wireless terminals are not limited to the above cited ones, but can be more diversified.

Meanwhile, the data which have been received through the wire switching station 17 may pass through the user PC 18 or may not pass through the user PC 18 to be transmitted to the user's captioning language training terminal 21.

The captioning language learning data which have been transmitted to the wire or wireless terminal 19, 28, 22, 23, 24, 25, 26 or 27 pass through the communication interface of the user's captioning language training terminal to be stored in the memory section. The data thus stored can be played to be learned by the user.

Meanwhile, an external caption data memory module may be detachably attached, so that the learning may be directly carried out even without the reception of the data through the wire or wireless data communication.

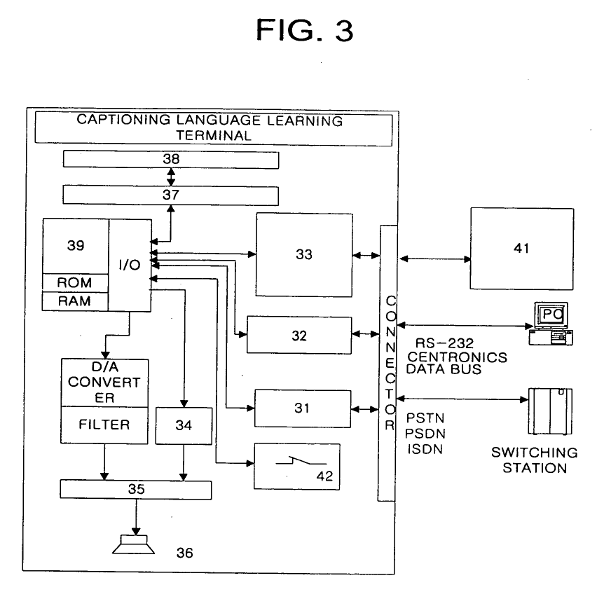

FIG. 3 is a block diagram showing the constitution of the captioning language learning terminal utilizing the communication network according to the present invention. As shown in the drawing, the terminal includes: a modem section 31 for receiving the captioning language learning data from the captioning language learning network server 11 through the wire switching station; a communication interface section 32 for receiving the data from the wire or wireless terminal or a PC in a form readable by the internal devices; an internal captioning language learning data memory section 33 for storing the audio and caption data; a CODEC section 34 for converting the audio data to analogue audio data; an amplifying section 35; an LCD driver 7 for driving an LCD display section 38 to display the caption data; and a DSP/CPU section 39 for processing the audio and captioning learning data and for controlling the whole terminal.

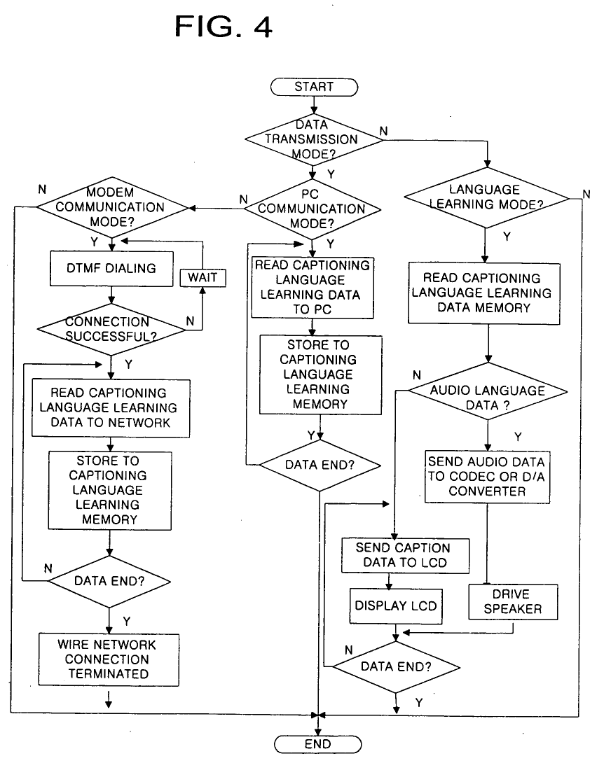

FIG. 4 is a flow chart showing the operation of the captioning language learning terminal of FIG. 3 according to the present invention.

During an inputting of the captioning language learning data from the external, if the PC is not passed through, but if the current status is a modem communication mode directly passing through the wire switching station, then the modem 31 is driven to carry out a DTMF dialing, so that a connection can be formed with the wire switching station, and that the captioning language learning data can be received through the modem 31.

Meanwhile, if it is a PC communication mode in which the captioning language learning data are received either through a wire switching station by using a PC, or through the wire or wireless communication terminal, then the data are received through the communication interface section 32.

The DSP/CPU section 39 receives the audio and caption data either through the modem 31 or the communication interface section 32 to process and control them so as to store them into an internal captioning data memory section 33.

When the data storing is completed, the data reception is completed after terminating the wire connection of the modem section 31 under the modem communication mode, while the reception is directly ended under the PC communication mode.

Meanwhile, if the play switch of the switch section which is connected to the DSP/CPU section 39 is turned on, and thus if a language learning mode is established, then the DSP/CPU section reads the data from the data memory section 33. In accordance with the relevant address within the RAM, if it is audio data, then the data are sent to the CODEC section to be converted into analogue audio data. Then the data are amplified by the amplifying section 35 to be outputted through the speaker.

Meanwhile if the data of the data memory section 33 are caption data, then the data are sent to the LCD driving section 37, and the LCD display is driven, so that the audio and caption data would be played back.

Under the language learning mode, if the forward or reverse key is inputted, the next and preceding audio and caption data are played back, and thus the language learning is made possible.

Meanwhile, if an external captioning language training memory module 41 is detachably installed, then various learning data can be exchanged even without the wire or wireless receptions, thereby making it possible to carry out the learning.

The CODEC section 34 includes a D/A converter and a filter.

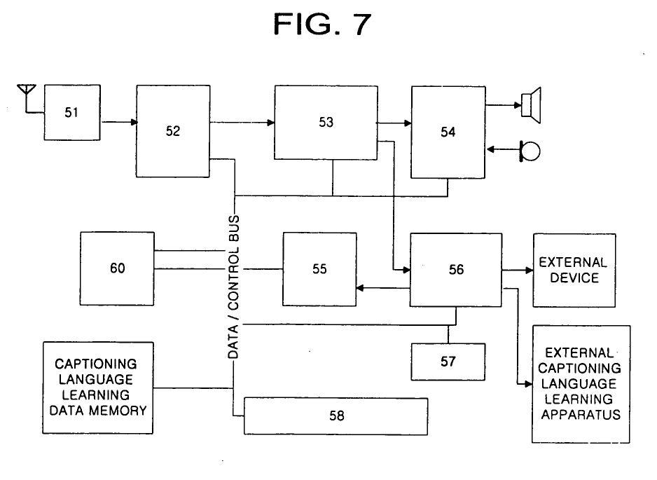

FIG. 7 is a block diagram showing the constitution of the wireless data communication terminal having the captioning language training function according to the present invention.

As shown in this drawing, the terminal includes: an FR/IF section 51 for receiving the data through an antenna to carry out RF-amplifications; a modem section 52 for demodulating the RF-amplified data signals; a protocol control section 53 for carrying out an extraction-control on the received data suitably to the communication protocol; a CODEC section 54 for converting the audio data into analogue audio data; a data transmission control section 56 for controlling the transmission routes in accordance with the kind of the data; a DSP/CPU section 55 for controlling the whole -terminal and for processing the audio learning data; a ROM/RAM section 60 for storing CPU programs and address data; an internal captioning language learning data memory section 59 for storing the audio and captioning learning data; and an LCD display section 58 for displaying the caption data.

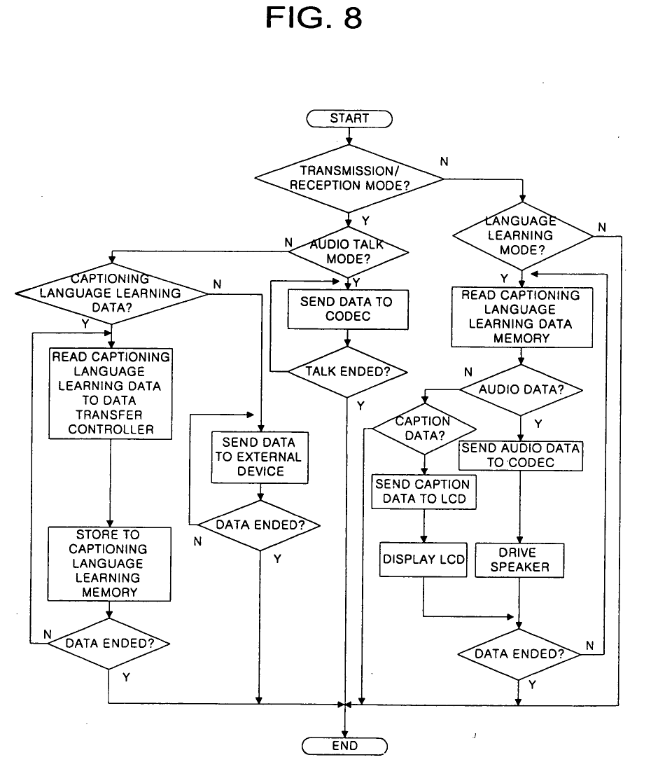

FIG. 8 is a flow chart showing the operation of the wireless data communication terminal of FIG. 7 according to the present invention.

When the captioning language learning data are inputted from the external through the wire or wireless communication network under the transmission/reception mode, the DSP/CPU section 55 checks a transmission/reception mode (Y) and an audio talk mode (N). The received data which have been received through the antenna are RF-amplified by the RF/IF section 51, and are demodulated into digital data signals during their passing through the modem section 52.

The data which have been outputted from the modem section 52 are transmitted to the protocol control section 53 so as to be extracted as reception data suitable to the communication protocol.

Under this condition, the DSP/CPU section 55 checks the transmission/reception mode (Y) and the audio talk mode (N). If the received data are audio data, then the data are outputted to the CODEC section 54 to be converted into analogue audio data signals.

Meanwhile, the DSP/CPU section 55 checks the transmission/reception mode (Y) and the audio talk mode (N). If the received data are information data other than captioning language learning data, then the data are outputted through the data transmission control section 56 to an external apparatus.

Meanwhile, the captioning language learning data which have been outputted from the protocol section 53 are processed and controlled by the DSP/CPU section 55 to be stored in the internal captioning language learning data memory section 59.

If the user selects the learning mode by pressing the play key of the key section 57, then the DSP/CPU section 55 checks the transmission/reception mode (Y) and the language learning mode (N), and reads the data of the data memory section 59. Thus in accordance with the address of the internal RAM, if the data are audio data, then the data are sent to the CODEC section 54 to be converted into analogue audio data signals so as to be outputted through the speaker.

If the data which have been read from the data memory section 59 are caption data, the DSP/CPU section 55 carries out controls such that the caption data corresponding to the relevant audio data should be displayed to the LCD display section 58.

Further, when a forward or reverse key of the key section 57 is inputted under the language learning mode, the next and preceding audio and caption data are outputted through the LCD display section 58 and the speaker, so that repeated audio and caption language learning would be possible.

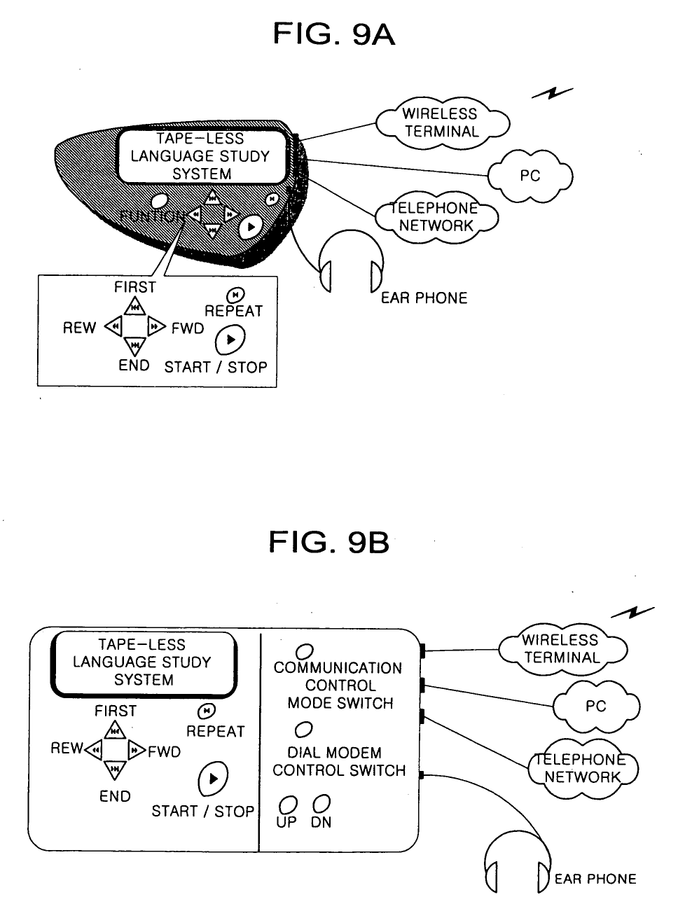

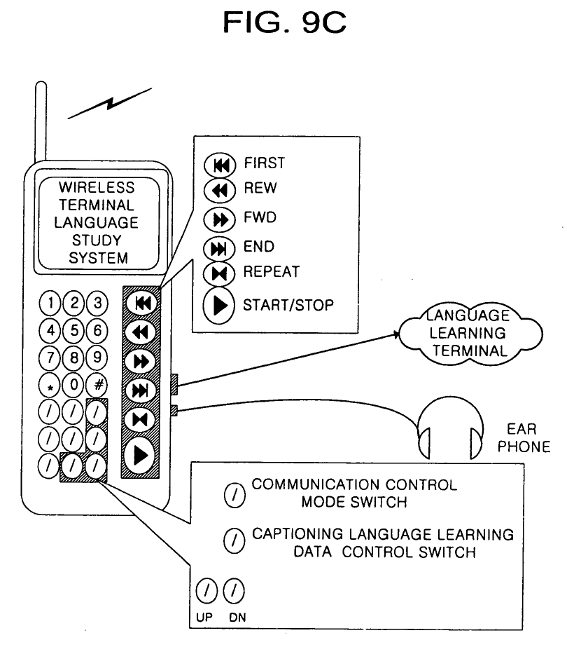

FIGS. 9A and 9B illustrate the external contours of the embodiments of the captioning language learning terminal according to the present invention. FIG. 9C illustrates the external contour of the wireless data communication terminal having the captioning language learning terminal according to the present invention.

These preferred embodiments of the present invention are just specific examples of the present invention, and therefore, its external contours can be altered in various ways without departing from the scope of the present invention.

According to the present invention as described above, the caption and audio data can be watched and listened without using the conventional captioning type cassette tape and player.

Further, the carrying is convenient, and malfunctions do not occur, so that foreign languages can be learned in a convenient way. Particularly, the data updating is possible any time by employing an on-line data base server. If a captioning language learning network server is utilized, the data transmission and updating are possible any time without being restricted by the site under the lack of PC. Therefore, the user can learn foreign languages without being bored.

1-5. (cancelled).

6. A wireless data communication terminal having a caption language learning function, comprising:
a radio frequency/intermediate frequency (RF/IF) unit for receiving and amplifying data including caption language learning data via a wireless communication network, the RF/IF unit outputting a wireless data signal;
a modem for demodulating the wireless data signal output from the RF/IF unit;
a protocol controller for receiving the data demodulated and output by the modem and generating data fitting to a communication protocol;
a coder-decoder (CODEC) for converting the digital audio data generated by the protocol controller into analog audio signals and outputting the analog audio signals;
a data transmitting controller for controlling the transmission of the caption data generated by the protocol controller to a displayer;
a Digital Signal Processor/Central Processing Unit (DSP/CPU) for storing the caption language learning data in a caption language learning data memory, and when selecting a play mode, reading the caption language learning data from the caption language learning data memory, and converting and outputting the read data via the displayer and a speaker; and
a Read Only Memory (ROM) and a Random Access Memory (RAM) for storing operating programs, data and addresses of the DSP/CPU.

7. The tenninal of claim 49, wherein the terminal further comprises a key unit for inputting information on operation modes and function selection to the DSP/CPU.
